(19) United States
(12) Patent Application Publication
(10) Pub. No.: US 2013/0008925 A1
(43) Pub. Date: Jan. 10, 2013

(54) Grease Gun with Enhanced Speed and Pressure

(76) Inventor: Mei-Hui Wang, Hemei Township (TW)

(21) Appl. No.: 13/176,785

(22) Filed: Jul. 6, 2011

(51) Int. Cl. F16N 5/00

(52) U.S. Cl. 222/263

(57) ABSTRACT

A grease gun includes a base, a storage unit, a feeding unit, and a boosting device. Thus, when the grease is forced and squeezed to flow through the interior of the boosting device, the boosting gear of the boosting device is rotated to stir, pressurize and accelerate the grease so as to increase the flow rate and pressure of the grease so that the grease is injected outward quickly and smoothly.

### BACKGROUND OF THE INVENTION

1. Field of the Invention

The present invention relates to a grease gun and, more particularly, to a grease gun that is operated in a manual, motorized or pneumatic manner.

2. Description of the Related Art

A conventional motorized grease gun in accordance with the prior art shown in FIG. 11 comprises a barrel 50 having an interior provided with a non-circular receiving space 51 containing grease therein, a front cover 52 mounted on a front end of the barrel 50 and having a central portion provided with a mounting seat 522 and a surface provided with a nozzle 521, a rear cover 53 mounted on a rear end of the barrel 50 and having a central portion provided with a shaft hole 531, a threaded rod 54 rotatably mounted in the receiving space 51 of the barrel 50 and having a front end rotatably mounted in the mounting seat 522 of the front cover 52 and a rear end rotatably mounted in the shaft hole 531 of the rear cover 53, a non-circular press plate 55 movably mounted in the receiving space 51 of the barrel 50 and having a central portion provided with a screw bore 551 screwed onto the threaded rod 54, and a power unit 60 connected with the threaded rod 54 to drive the threaded rod 54. In operation, each of the press plate 55 and the receiving space 51 of the barrel 50 has a non-circular shape so that the press plate 55 cannot be rotated relative to the barrel 50. At this time, the screw bore 551 of the press plate 55 is screwed onto the threaded rod 54 so that when the threaded rod 54 is rotated by the power unit 60, the press plate 55 is forced to move axially in the receiving space 51 of the barrel 50. Thus, the press plate 55 is moved by rotation of the threaded rod 54 and is forced toward the front cover 52 to compress the grease in the receiving space 51 of the barrel 50 so that the grease in the receiving space 51 of the barrel 50 is injected outward from the nozzle 521 of the front cover 52 for use with a user. However, the grease is compressed by the press plate 55 only so that the grease has a lower output flow rate and a lower pressure and cannot be injected outward from the nozzle 521 of the front cover 52 quickly and smoothly, thereby causing inconvenience to the user in filling the grease.

### BRIEF SUMMARY OF THE INVENTION

In accordance with the present invention, there is provided a grease gun, comprising a base, a storage unit, a feeding unit, and a boosting device. The base has an interior provided with a receiving space and has an end face provided with a shaft hole. The base has a surface provided with a passage. The storage unit includes a barrel having a first end connected with the base, and an end cap mounted on a second end of the barrel. The barrel of the storage unit has an interior provided with a receiving chamber. The end cap of the storage unit has a side provided with a pivot hole. The feeding unit includes a wormwheel rotatably mounted in the receiving space of the base, a threaded rod rotatably mounted on the end cap of the storage unit and connected with the wormwheel, and a pressing plate movably mounted in the receiving chamber of the barrel and connected with the threaded rod. The wormwheel of the feeding unit has a first end provided with a mounting portion rotatably mounted in the shaft hole of the base and has a second end provided with a fitting portion. The mounting portion of the wormwheel has an interior provided with a mounting recess. The fitting portion of the wormwheel has an interior provided with a locking recess. The threaded rod of the feeding unit has a first end provided with a driving portion locked in the locking recess of the fitting portion so that the wormwheel of the feeding unit is rotatable in concert with the threaded rod. The threaded rod of the feeding unit has a second end provided with a pivot portion pivotally mounted in the pivot hole of the end cap, and an actuating portion protruded outward from the pivot hole of the end cap. The threaded rod of the feeding unit has a periphery provided with an external thread. The pressing plate of the feeding unit has an interior provided with an internal thread screwed onto the external thread of the threaded rod so that the pressing plate of the feeding unit is movable axially in the receiving chamber of the barrel by rotation of the threaded rod relative to the barrel of the storage unit. The boosting device includes a mounting seat connected with the base, a boosting gear rotatably mounted in the mounting seat and connected with the wormwheel of the feeding unit, a cover connected with the mounting seat, and a connecting pipe connected with the cover. The mounting seat of the boosting device has an interior provided with a mounting chamber. The mounting seat of the boosting device has a first side provided with an inlet hole connected between the passage of the base and the mounting chamber and has a second side provided with a flow channel connected to the mounting chamber. The boosting gear of the boosting device is rotatably mounted in the mounting chamber of the mounting seat and has a side provided with a connecting portion secured in the mounting recess of the mounting portion of the wormwheel so that the boosting gear of the boosting device is rotatable in concert with the wormwheel of the feeding unit. The cover of the boosting device has a side provided with an outlet hole connected to the flow channel of the mounting seat.

The primary objective of the present invention is to provide a grease gun with enhanced speed and pressure.

According to the primary advantage of the present invention, when the grease flows through the mounting chamber of the mounting seat, the boosting gear of the boosting device is rotated in the mounting chamber of the mounting seat to stir, pressurize and accelerate the grease so as to increase the flow rate and pressure of the grease so that the grease is injected from the connecting pipe quickly and smoothly.

According to a further advantage of the present invention, the actuating portion of the threaded rod is directly driven by a motorized or pneumatic tool so as to move the pressing plate quickly.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a grease gun in accordance with the preferred embodiment of the present invention.

FIG. 2 is an exploded perspective view of the grease gun as shown in FIG. 1.

FIG. 2a is a locally enlarged view of the grease gun as shown in FIG. 2.

FIG. 3 is a front cross-sectional view of the grease gun as shown in FIG. 1.

FIG. 3a is a locally enlarged view of the grease gun as shown in FIG. 3.

FIG. 4 is a partially enlarged view of the grease gun as shown in FIG. 3.

FIG. 4a is a locally enlarged view of the grease gun as shown in FIG. 4.

FIG. 5 is a partially perspective cross-sectional view of the grease gun as shown in FIG. 1.

FIG. 6 is a schematic operational view of the grease gun as shown in FIG. 1 in use.

FIG. 7 is a schematic operational view of the grease gun as shown in FIG. 1 in use.

FIG. 8 is a schematic operational view of the grease gun as shown in FIG. 1 in use.

FIG. 9 is a schematic operational view of the grease gun as shown in FIG. 4.

FIG. 9a is a locally enlarged view of the grease gun as shown in FIG. 9.

FIG. 10 is a perspective view of a grease gun in accordance with another preferred embodiment of the present invention.

FIG. 11 is an exploded perspective view of a conventional grease gun in accordance with the prior art.

### DETAILED DESCRIPTION OF THE INVENTION

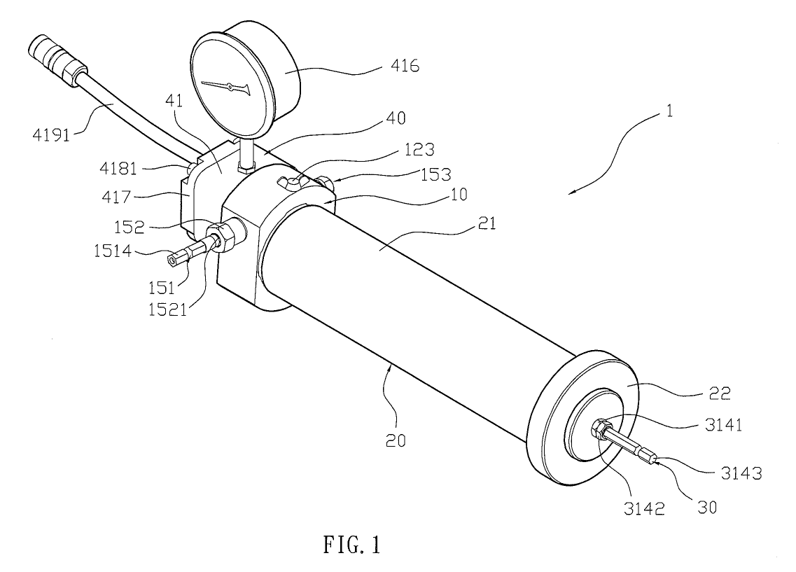

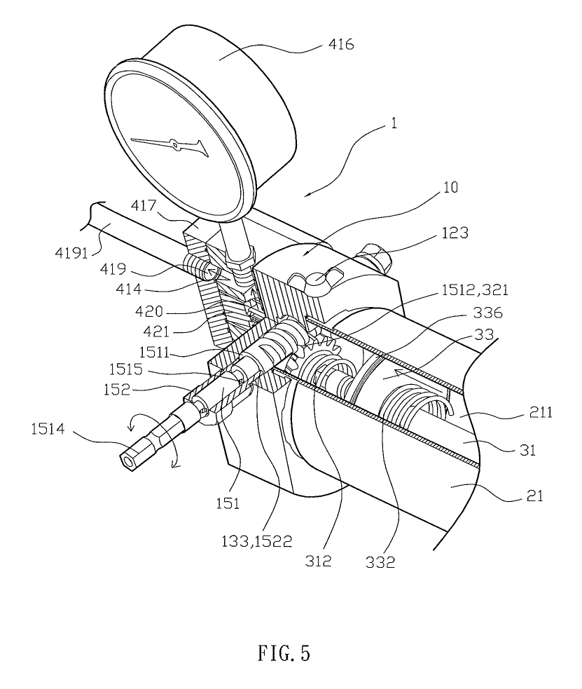

Referring to the drawings and initially to FIGS. 1-5, a grease gun 1 in accordance with the preferred embodiment of the present invention comprises a base 10, a storage unit 20, a feeding unit 30, and a boosting device 40.

The base 10 has an interior provided with a receiving space 13 and has an end face provided with a shaft hole 131. The base 10 has a surface provided with a passage 132. The shaft hole 131 of the base 10 is connected to the receiving space 13, and the passage 132 of the base 10 is connected to the receiving space 13.

The storage unit 20 includes a barrel 21 having a first end connected with the base 10, and an end cap 22 mounted on a second end of the barrel 21.

The barrel 21 of the storage unit 20 has an interior provided with a receiving chamber 211. The receiving chamber 211 of the barrel 21 has a non-circular shape and is connected to the receiving space 13 of the base 10. The second end of the barrel 21 has a periphery provided with an outer threaded portion 213.

The end cap 22 of the storage unit 20 has a side provided with a pivot hole 222. The pivot hole 222 of the end cap 22 is connected to the receiving chamber 211 of the barrel 21. The end cap 22 of the storage unit 20 has an inner wall provided with an inner threaded portion 221 screwed onto the outer threaded portion 213 of the barrel 21.

The feeding unit 30 includes a wormwheel 32 rotatably mounted in the receiving space 13 of the base 10, a threaded rod 31 rotatably mounted on the end cap 22 of the storage unit 20 and connected with the wormwheel 32, and a pressing plate 33 movably mounted in the receiving chamber 211 of the barrel 21 and connected with the threaded rod 31.

The wormwheel 32 of the feeding unit 30 has a first end provided with a mounting portion 324 rotatably mounted in the shaft hole 131 of the base 10 and has a second end provided with a fitting portion 325. The mounting portion 324 of the wormwheel 32 has an interior provided with a mounting recess 3241. The mounting recess 3241 of the wormwheel 32 has a non-circular shape. The fitting portion 325 of the wormwheel 32 has an interior provided with a locking recess 3251. The locking recess 3251 of the wormwheel 32 has a non-circular shape. The wormwheel 32 of the feeding unit 30 has a periphery provided with a first worm thread 321. The grease gun 1 further comprises a lubricating bearing (not shown) mounted between the mounting portion 324 of the wormwheel 32 and the shaft hole 131 of the base 10.

The threaded rod 31 of the feeding unit 30 is supported between the wormwheel 32 and the end cap 22 of the storage unit 20 and is rotatable in the receiving chamber 211 of the barrel 21. The threaded rod 31 of the feeding unit 30 has a first end provided with a driving portion 312 locked in the locking recess 3251 of the fitting portion 325 so that the wormwheel 32 of the feeding unit 30 is rotatable in concert with the threaded rod 31. The driving portion 312 of the threaded rod 31 has a non-circular shape. The threaded rod 31 of the feeding unit 30 has a second end provided with a pivot portion 313 pivotally mounted in the pivot hole 222 of the end cap 22, and an actuating portion 3143 protruded outward from the pivot hole 222 of the end cap 22. The actuating portion 3143 of the threaded rod 31 has a non-circular shape. The second end of the threaded rod 31 is further provided with a threaded locking portion 314 protruded outward from the pivot hole 222 of the end cap 22, and the feeding unit 30 further includes a locking nut 3141 screwed onto the threaded locking portion 314 of the threaded rod 31 and abutting the end cap 22, and a pressing nut 3142 screwed onto the threaded locking portion 314 of the threaded rod 31 and pressing the locking nut 3141. The second end of the threaded rod 31 is further provided with a stepped stop edge 315 abutting a side of the pivot hole 222 of the end cap 22 to limit the threaded rod 31 of the feeding unit 30 to the end cap 22 of the storage unit 20, and the storage unit 20 further includes a lubricating bearing 223 mounted between the pivot portion 313 of the threaded rod 31 and the pivot hole 222 of the end cap 22 and abutting located between the stop edge 315 of the threaded rod 31 and the pivot hole 222 of the end cap 22. The threaded rod 31 of the feeding unit 30 has a periphery provided with an external thread 311. The external thread 311 of the threaded rod 31 is disposed between the driving portion 312 and the stop edge 315, the stop edge 315 of the threaded rod 31 is disposed between the external thread 311 and the pivot portion 313, the pivot portion 313 of the threaded rod 31 is disposed between the stop edge 315 and the threaded locking portion 314, and the threaded locking portion 314 of the threaded rod 31 is disposed between the pivot portion 313 and the actuating portion 3143.

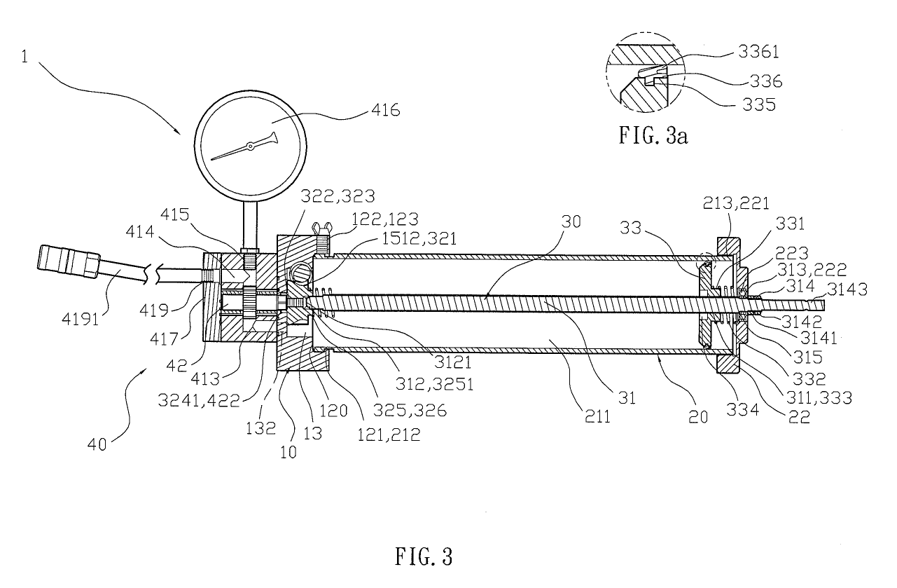

The pressing plate 33 of the feeding unit 30 has a non-circular shape matching that of the receiving chamber 211 of the barrel 21. The pressing plate 33 of the feeding unit 30 has an interior provided with an internal thread 333 screwed onto the external thread 311 of the threaded rod 31 so that the pressing plate 33 of the feeding unit 30 is movable axially in the receiving chamber 211 of the barrel 21 by rotation of the threaded rod 31 relative to the barrel 21 of the storage unit 20. The pressing plate 33 of the feeding unit 30 has a periphery provided with a retaining groove 335 for mounting a sealing ring 336 (see FIG. 3a) which presses an inner wall of the barrel 21. The sealing ring 336 of the feeding unit 30 has an outer wall provided with a pressing lip 3361 to seal the inner wall of the barrel 21.

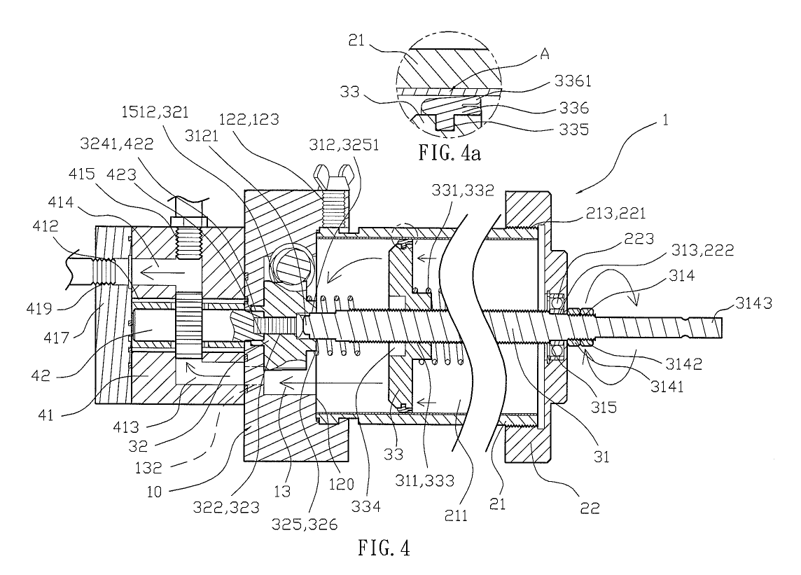

A package bag “A” (see FIG. 4a) containing grease is received in the receiving chamber 211 of the barrel 21 and is located between the barrel 21 of the storage unit 20 and the sealing ring 336 of the feeding unit 30. At this time, the pressing lip 3361 of the sealing ring 336 presses the package bag “A” closely. Thus, the pressing plate 33 of the feeding unit 30 is movable axially in the receiving chamber 211 of the barrel 21 to compress and squeeze the grease in the package bag “A”.

The boosting device 40 includes a mounting seat 41 connected with the base 10, a boosting gear 42 rotatably mounted in the mounting seat 41 and connected with the wormwheel 32 of the feeding unit 30, a cover 417 connected with the mounting seat 41, and a connecting pipe 4191 connected with the cover 417.

The mounting seat 41 of the boosting device 40 is located between the base 10 and the cover 417 and has an interior provided with a mounting chamber 412. The mounting seat 41 of the boosting device 40 has a first side provided with an inlet hole 413 connected between the passage 132 of the base 10 and the mounting chamber 412 and has a second side provided with a flow channel 414 connected to the mounting chamber 412. The mounting chamber 412 of the mounting seat 41 is connected to the shaft hole 131 of the base 10 and is connected between the inlet hole 413 and the flow channel 414. The mounting seat 41 of the boosting device 40 has a periphery provided with a connecting hole 415 connected to the flow channel 414 or the inlet hole 413, and the grease gun 1 further comprises a pressure gauge 416 fitted into the connecting hole 415 of the mounting seat 41 and connected to the flow channel 414 or the inlet hole 413 to measure the pressure in the flow channel 414 of the mounting seat 41.

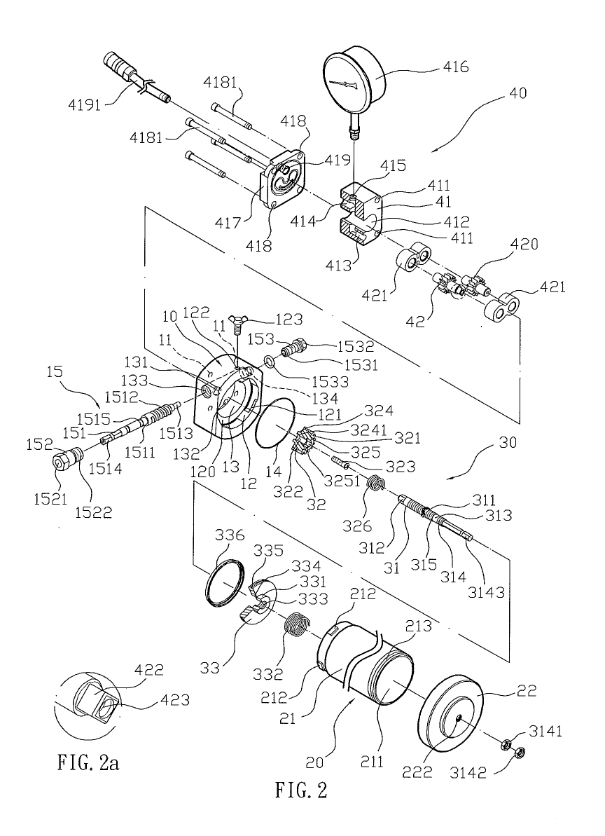

The boosting gear 42 of the boosting device 40 is rotatably mounted in the mounting chamber 412 of the mounting seat 41 and has a side provided with a connecting portion 422 (see FIG. 2a) secured in the mounting recess 3241 of the mounting portion 324 of the wormwheel 32 so that the boosting gear 42 of the boosting device 40 is rotatable in concert with the wormwheel 32 of the feeding unit 30. The connecting portion 422 of the boosting gear 42 has a non-circular shape.

The cover 417 of the boosting device 40 is located between the mounting seat 41 and the connecting pipe 4191 and has a side provided with an outlet hole 419 connected to the flow channel 414 of the mounting seat 41. The connecting pipe 4191 of the boosting device 40 is removably connected with the cover 417 and is connected to the outlet hole 419 of the cover 417.

The boosting device 40 further includes a secondary boosting gear 420 rotatably mounted in the mounting chamber 412 of the mounting seat 41 and meshing with the boosting gear 42, and two limiting blocks 421 mounted in the mounting chamber 412 of the mounting seat 41 and located at two opposite sides of each of the boosting gear 42 and the secondary boosting gear 420 respectively to limit the boosting gear 42 and the secondary boosting gear 420 in the mounting chamber 412 of the mounting seat 41.

In the preferred embodiment of the present invention, the base 10 is provided with a plurality of threaded fastening holes 11, the mounting seat 41 of the boosting device 40 is provided with a plurality of fixing holes 411, the cover 417 of the boosting device 40 is provided with a plurality of fixing bores 418, and the grease gun 1 further comprises a plurality of fastening bolts 4181 extended through the fixing bores 418 of the cover 417 and the fixing holes 411 of the mounting seat 41 and screwed into the fastening holes 11 of the base 10 to combine the base 10, the mounting seat 41 and the cover 417 together.

The base 10 has an open end provided with a rotation space 12 to allow insertion and rotation of the barrel 21 of the storage unit 20. The rotation space 12 of the base 10 is connected to the receiving space 13 and has a dimension greater than that of the receiving space 13 so that a stepped shoulder 120 is defined between the receiving space 13 and the rotation space 12 of the base 10, and the grease gun 1 further comprises an O-ring 14 received in the rotation space 12 of the base 10 and biased between the shoulder 120 of the base 10 and the barrel 21 of the storage unit 20. The rotation space 12 of the base 10 has a periphery provided with a plurality of locking slots 121. The first end of the barrel 21 is inserted into the rotation space 12 of the base 10 and stopped by the shoulder 120 of the base 10. The first end of the barrel 21 has a periphery provided with a plurality of locking ribs 212 inserted into and locked in the locking slots 121 to lock the barrel 21 of the storage unit 20 onto the base 10. The base 10 has a peripheral wall provided with a screw bore 122 connected to the rotation space 12, and the grease gun 1 further comprises a set screw 123 screwed into the screw bore 122 of the base 10 and pressing the barrel 21 of the storage unit 20 to position the barrel 21 of the storage unit 20 on the base 10.

The wormwheel 32 of the feeding unit 30 has an interior provided with a through hole 322. The through hole 322 of the wormwheel 32 is connected between the mounting recess 3241 of the mounting portion 324 and the locking recess 3251 of the fitting portion 325. The connecting portion 422 of the boosting gear 42 has an interior provided with a screw hole 423 (see FIG. 2a), and the grease gun 1 further comprises a locking screw 323 extended through the through hole 322 of the wormwheel 32 and screwed into the screw hole 423 of the boosting gear 42 to combine the boosting gear 42 with the wormwheel 32. The driving portion 312 of the threaded rod 31 has an end face provided with a protrusion 3121 inserted into the locking recess 3251 of the fitting portion 325 and abutting the locking screw 323 so that the driving portion 312 of the threaded rod 31 is inserted into the locking recess 3251 of the fitting portion 325 easily and quickly.

The pressing plate 33 of the feeding unit 30 has a first side provided with a lug 331 facing the end cap 22 of the storage unit 20 and a second side provided with a depression 334 facing the fitting portion 325 of the wormwheel 32, and the grease gun 1 further comprises an elastic member 332 mounted on the lug 331 of the pressing plate 33 and movable with the pressing plate 33 to abut the end cap 22 of the storage unit 20, and a restoring member 326 mounted on the fitting portion 325 of the wormwheel 32 and facing the depression 334 of the pressing plate 33. The depression 334 of the pressing plate 33 is movable with the pressing plate 33 to abut the restoring member 326.

The grease gun 1 further comprises an energy-saving actuating mechanism 15 mounted on the base 10 and connected with the feeding unit 30 to drive the feeding unit 30. The base 10 has a first side provided with a first threaded hole 133 connected to the receiving space 13 and a second side provided with a second threaded hole 134 connected to the receiving space 13. The energy-saving actuating mechanism 15 includes a first threaded bushing 152 screwed into the first threaded hole 133 of the base 10, a second threaded bushing 153 screwed into the second threaded hole 134 of the base 10, and a worm shaft 151 mounted between the first threaded bushing 152 and the second threaded bushing 153 and meshing with the wormwheel 32 of the feeding unit 30 to drive the wormwheel 32 and the threaded rod 31 of the feeding unit 30.

The first threaded bushing 152 of the energy-saving actuating mechanism 15 has an interior provided with a first pivot bore 1521 to receive the worm shaft 151 and has an outer wall provided with an outer thread 1522 screwed into the first threaded hole 133 of the base 10.

The second threaded bushing 153 of the energy-saving actuating mechanism 15 has an interior provided with a second pivot bore 1531 to receive the worm shaft 151 and has a distal end provided with an enlarged stop portion 1532 abutting the base 10.

The worm shaft 151 of the energy-saving actuating mechanism 15 is rotatably mounted in the receiving space 13 of the base 10 and has a first end provided with a driving head 1514 rotatably mounted in the first pivot bore 1521 of the first threaded bushing 152 and a second end provided with a pivot rod 1513 rotatably mounted in the second pivot bore 1531 of the second threaded bushing 153. The driving head 1514 of the worm shaft 151 has a non-circular shape and protrudes outward from the first pivot bore 1521 of the first threaded bushing 152. The worm shaft 151 of the energy-saving actuating mechanism 15 has a periphery provided with a second worm thread 1512 meshing with the first worm thread 321 of the wormwheel 32 so that the wormwheel 32 is rotatable with the worm shaft 151. The worm shaft 151 of the energy-saving actuating mechanism 15 has a surface provided with a stepped stop flange 1511 abutting a side of the first threaded bushing 152 so that the worm shaft 151 is limited by the first threaded bushing 152. The stop flange 1511 of the worm shaft 151 is disposed between the driving head 1514 and the second worm thread 1512, and the second worm thread 1512 of the worm shaft 151 is disposed between the stop flange 1511 and the pivot rod 1513.

The energy-saving actuating mechanism 15 further includes a first gasket 1515 mounted on the worm shaft 151 and biased between the worm shaft 151 and the first pivot bore 1521 of the first threaded bushing 152, and a second gasket 1533 mounted on the second threaded bushing 153 and biased between the second threaded bushing 153 and the second threaded hole 134 of the base 10.

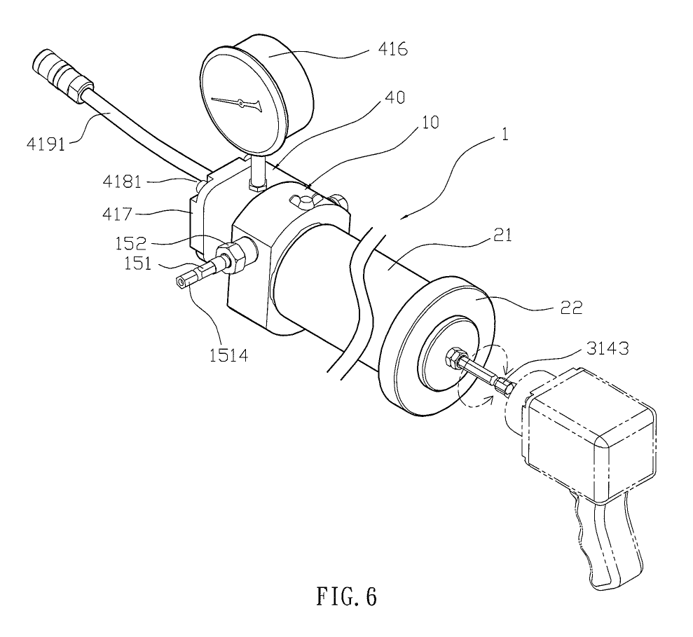

In operation, referring to FIG. 6 with reference to FIGS. 1-5, when the actuating portion 3143 of the threaded rod 31 is driven by a motorized or pneumatic tool as shown in FIG. 6, the threaded rod 31 is rotated so that the pressing plate 33 is moved axially in the receiving chamber 211 of the barrel 21 by rotation of the threaded rod 31. In such a manner, the pressing plate 33 is moved toward the base 10 as shown in FIG. 4 to compress and squeeze the grease in the package bag “A” so that the grease is forced to flow through the receiving space 13 and the passage 132 of the base 10, the inlet hole 413, the mounting chamber 412 and the flow channel 414 of the mounting seat 41, and the outlet hole 419 of the cover 417 into the connecting pipe 4191 and is injected outward from the connecting pipe 4191 for use with a user. At this time, when the threaded rod 31 is rotated, the wormwheel 32 of the feeding unit 30 is rotated by the threaded rod 31 to rotate the boosting gear 42 of the boosting device 40. Thus, when the grease flows through the mounting chamber 412 of the mounting seat 41, the boosting gear 42 of the boosting device 40 is rotated in the mounting chamber 412 of the mounting seat 41 to stir, pressurize and accelerate the grease so as to increase the flow rate and pressure of the grease so that the grease is injected from the connecting pipe 4191 quickly and smoothly.

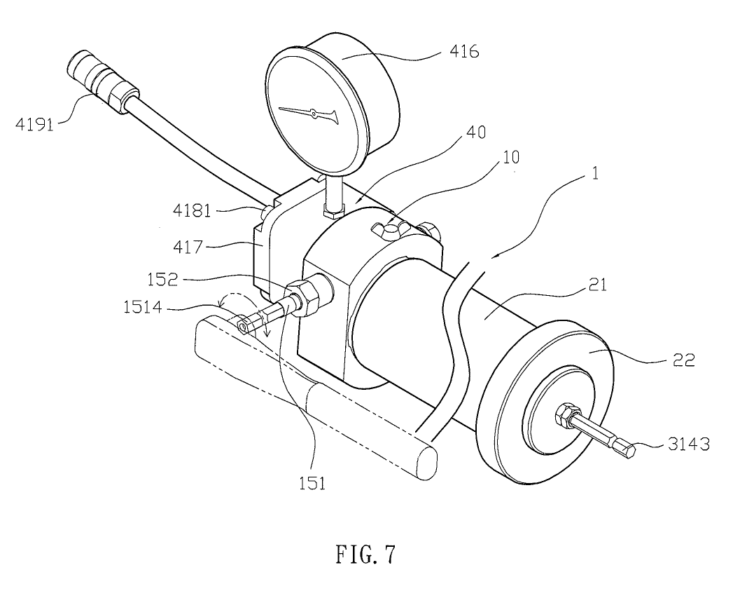

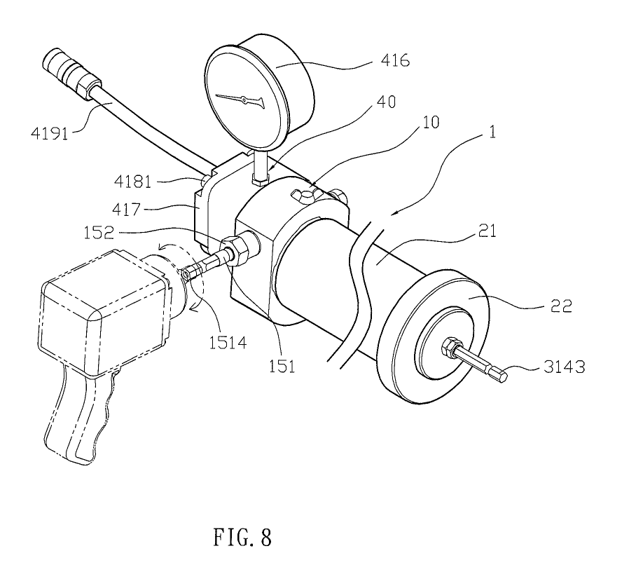

Alternatively, when the driving head 1514 of the worm shaft 151 is driven by a hand tool as shown in FIG. 7 or by a motorized or pneumatic tool as shown in FIG. 8, the worm shaft 151 is rotated to rotate the wormwheel 32 so that the threaded rod 31 and the boosting gear 42 are rotated by the wormwheel 32. Thus, the threaded rod 31 is rotated to drive the pressing plate 33 so as to squeeze the grease, and the boosting gear 42 is rotated to pressurize and accelerate the grease.

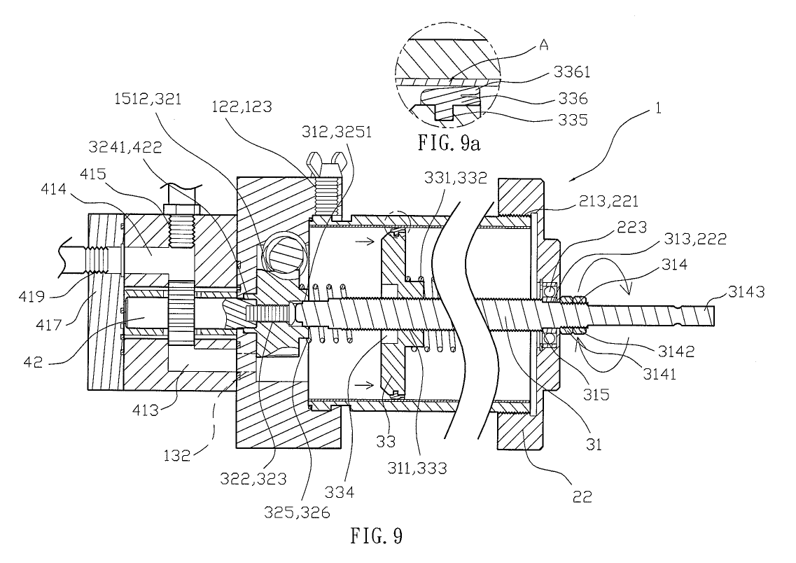

Referring to FIGS. 9 and 9a, when the actuating portion 3143 of the threaded rod 31 is driven in the reverse direction, so that the pressing plate 33 is moved backward to release the grease.

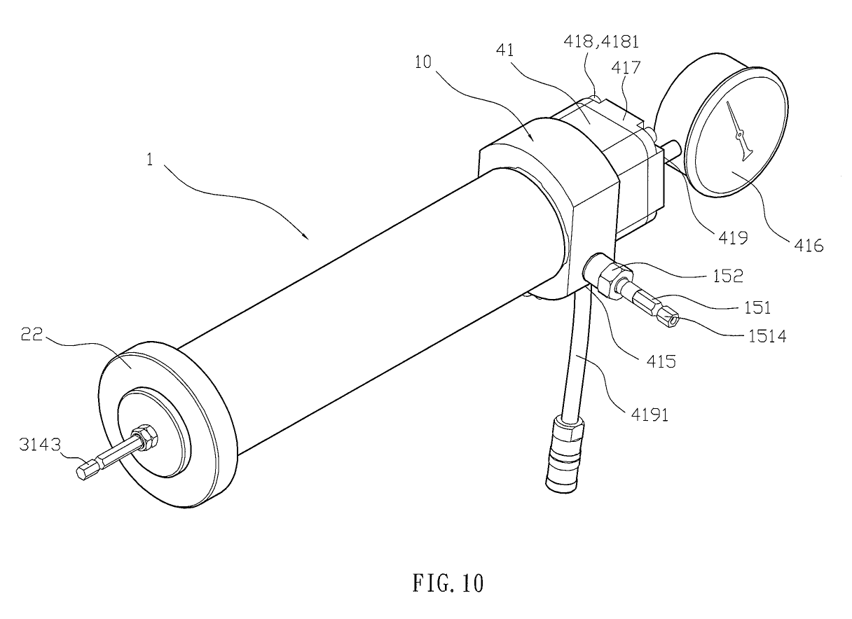

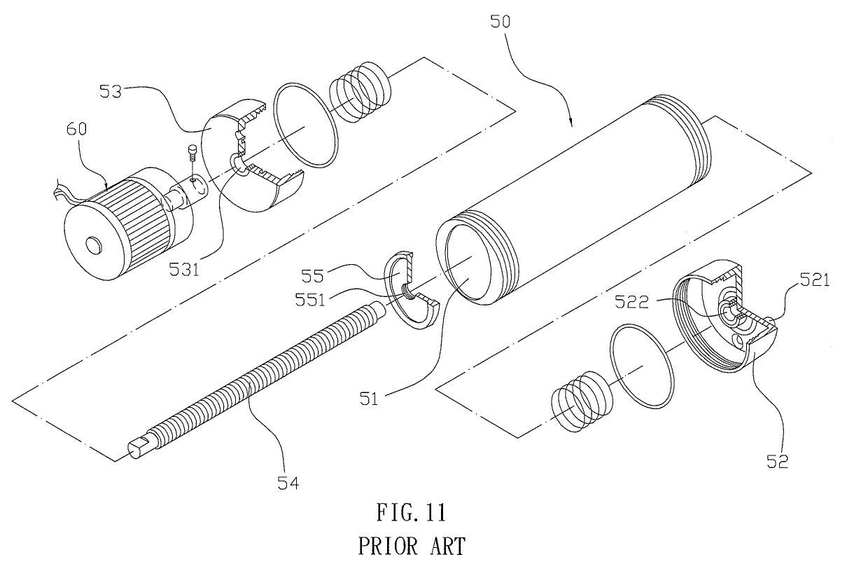

Referring to FIG. 10, the positions of the pressure gauge 416 and the connecting pipe 4191 are interchanged. Thus, the pressure gauge 416 is connected with the cover 417 and is fitted into the outlet hole 419 of the cover 417, and the connecting pipe 4191 is connected with the mounting seat 41 and is connected to the connecting hole 415 of the mounting seat 41.

Accordingly, when the grease flows through the mounting chamber 412 of the mounting seat 41, the boosting gear 42 of the boosting device 40 is rotated in the mounting chamber 412 of the mounting seat 41 to stir, pressurize and accelerate the grease so as to increase the flow rate and pressure of the grease so that the grease is injected from the connecting pipe 4191 quickly and smoothly. In addition, the tooth ratio of the second worm thread 1512 of the worm shaft 151 and the first worm thread 321 of the wormwheel 32 has a preset value so that the worm shaft 151 can drive the wormwheel 32 in an energy-saving manner to facilitate a user operating the grease gun manually. Further, the pressure gauge 416 can measure the pressure in the flow channel 414 of the mounting seat 41 to facilitate the user observing the pressure of the grease gun. Further, the actuating portion 3143 of the threaded rod 31 is directly driven by a motorized or pneumatic tool so as to move the pressing plate 33 quickly. Further, the grease gun is operated manually by action of the energy-saving actuating mechanism 15 and is operated automatically by action of the feeding unit 30, thereby facilitating the versatility of the grease gun.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A grease gun, comprising:
a base, a storage unit, a feeding unit, and a boosting device, wherein
the base has an interior provided with a receiving space and has an end face provided with a shaft hole;
the base has a surface provided with a passage;
the storage unit includes:
a barrel having a first end connected with the base; and
an end cap mounted on a second end of the barrel;
the barrel of the storage unit has an interior provided with a receiving chamber;
the end cap of the storage unit has a side provided with a pivot hole;
the feeding unit includes:
a wormwheel rotatably mounted in the receiving space of the base;
a threaded rod rotatably mounted on the end cap of the storage unit and connected with the wormwheel; and
a pressing plate movably mounted in the receiving chamber of the barrel and connected with the threaded rod;
the wormwheel of the feeding unit has a first end provided with a mounting portion rotatably mounted in the shaft hole of the base and has a second end provided with a fitting portion;
the mounting portion of the wormwheel has an interior provided with a mounting recess;
the fitting portion of the wormwheel has an interior provided with a locking recess;
the threaded rod of the feeding unit has a first end provided with a driving portion locked in the locking recess of the fitting portion so that the wormwheel of the feeding unit is rotatable in concert with the threaded rod;
the threaded rod of the feeding unit has a second end provided with a pivot portion pivotally mounted in the pivot hole of the end cap, and an actuating portion protruded outward from the pivot hole of the end cap;
the threaded rod of the feeding unit has a periphery provided with an external thread;
the pressing plate of the feeding unit has an interior provided with an internal thread screwed onto the external thread of the threaded rod;
the boosting device includes:
a mounting seat connected with the base;
a boosting gear rotatably mounted in the mounting seat and connected with the wormwheel of the feeding unit;
a cover connected with the mounting seat; and
a connecting pipe connected with the cover;
the mounting seat of the boosting device has an interior provided with a mounting chamber;
the mounting seat of the boosting device has a first side provided with an inlet hole connected between the passage of the base and the mounting chamber and has a second side provided with a flow channel connected to the mounting chamber;
the boosting gear of the boosting device is rotatably mounted in the mounting chamber of the mounting seat and has a side provided with a connecting portion secured in the mounting recess of the mounting portion of the wormwheel so that the boosting gear of the boosting device is rotatable in concert with the wormwheel of the feeding unit;
the cover of the boosting device has a side provided with an outlet hole connected to the flow channel of the mounting seat.

2. The grease gun of claim 1, wherein the boosting device further includes:
a secondary boosting gear rotatably mounted in the mounting chamber of the mounting seat and meshing with the boosting gear; and
two limiting blocks mounted in the mounting chamber of the mounting seat and located at two opposite sides of each of the boosting gear and the secondary boosting gear respectively to limit the boosting gear and the secondary boosting gear in the mounting chamber of the mounting seat.

3. The grease gun of claim 1, wherein
the second end of the threaded rod is further provided with a threaded locking portion protruded outward from the pivot hole of the end cap; and
the feeding unit further includes:
a locking nut screwed onto the threaded locking portion of the threaded rod and abutting the end cap; and
a pressing nut screwed onto the threaded locking portion of the threaded rod and pressing the locking nut.

4. The grease gun of claim 3, wherein the second end of the threaded rod is further provided with a stepped stop edge abutting a side of the pivot hole of the end cap to limit the threaded rod of the feeding unit to the end cap of the storage unit.

5. The grease gun of claim 4, wherein
the grease gun further comprises a lubricating bearing mounted between the mounting portion of the wormwheel and the shaft hole of the base;
the storage unit further includes a lubricating bearing mounted between the pivot portion of the threaded rod and the pivot hole of the end cap and abutting located between the stop edge of the threaded rod and the pivot hole of the end cap.

6. The grease gun of claim 1, wherein the pressing plate of the feeding unit has a periphery provided with a retaining groove for mounting a sealing ring which presses an inner wall of the barrel.

7. The grease gun of claim 6, wherein the sealing ring of the feeding unit has an outer wall provided with a pressing lip to seal the inner wall of the barrel.

8. The grease gun of claim 1, wherein the connecting pipe of the boosting device is removably connected with the cover and is connected to the outlet hole of the cover.

9. The grease gun of claim 1, wherein
the base has an open end provided with a rotation space to allow insertion and rotation of the barrel of the storage unit;
the rotation space of the base is connected to the receiving space and has a dimension greater than that of the receiving space;
a stepped shoulder is defined between the receiving space and the rotation space of the base;
the grease gun further comprises an 0-ring received in the rotation space of the base and biased between the shoulder of the base and the barrel of the storage unit;
the rotation space of the base has a periphery provided with a plurality of locking slots;
the first end of the barrel is inserted into the rotation space of the base and stopped by the shoulder of the base;
the first end of the barrel has a periphery provided with a plurality of locking ribs inserted into and locked in the locking slots to lock the barrel of the storage unit onto the base;
the base has a peripheral wall provided with a screw bore connected to the rotation space;
the grease gun further comprises a set screw screwed into the screw bore of the base and pressing the barrel of the storage unit to position the barrel of the storage unit on the base.

10. The grease gun of claim 1, wherein
the wormwheel of the feeding unit has an interior provided with a through hole;
the through hole of the wormwheel is connected between the mounting recess of the mounting portion and the locking recess of the fitting portion;
the connecting portion of the boosting gear has an interior provided with a screw hole;
the grease gun further comprises a locking screw extended through the through hole of the wormwheel and screwed into the screw hole of the boosting gear to combine the boosting gear with the wormwheel.

11. The grease gun of claim 1, wherein the driving portion of the threaded rod has an end face provided with a protrusion inserted into the locking recess of the fitting portion.

12. The grease gun of claim 1, wherein
the pressing plate of the feeding unit has a first side provided with a lug facing the end cap of the storage unit and a second side provided with a depression facing the fitting portion of the wormwheel;
the grease gun further comprises:
an elastic member mounted on the lug of the pressing plate and movable with the pressing plate to abut the end cap of the storage unit; and
a restoring member mounted on the fitting portion of the wormwheel and facing the depression of the pressing plate;
the depression of the pressing plate is movable with the pressing plate to abut the restoring member.

13. The grease gun of claim 1, wherein
the base has a first side provided with a first threaded hole connected to the receiving space and a second side provided with a second threaded hole connected to the receiving space;
the wormwheel of the feeding unit has a periphery provided with a first worm thread;
the grease gun further comprises an energy-saving actuating mechanism mounted on the base and connected with the feeding unit to drive the feeding unit;
the energy-saving actuating mechanism includes:
a first threaded bushing screwed into the first threaded hole of the base;
a second threaded bushing screwed into the second threaded hole of the base; and
a worm shaft mounted between the first threaded bushing and the second threaded bushing and meshing with the wormwheel of the feeding unit to drive the wormwheel and the threaded rod of the feeding unit;
the worm shaft of the energy-saving actuating mechanism has a periphery provided with a second worm thread meshing with the first worm thread of the wormwheel so that the wormwheel is rotatable with the worm shaft.

14. The grease gun of claim 13, wherein
the first threaded bushing of the energy-saving actuating mechanism has an interior provided with a first pivot bore to receive the worm shaft and has an outer wall provided with an outer thread screwed into the first threaded hole of the base;
the second threaded bushing of the energy-saving actuating mechanism has an interior provided with a second pivot bore to receive the worm shaft and has a distal end provided with an enlarged stop portion abutting the base;
the worm shaft of the energy-saving actuating mechanism is rotatably mounted in the receiving space of the base and has a first end provided with a driving head rotatably mounted in the first pivot bore of the first threaded bushing and a second end provided with a pivot rod rotatably mounted in the second pivot bore of the second threaded bushing.

15. The grease gun of claim 14, wherein
the driving head of the worm shaft protrudes outward from the first pivot bore of the first threaded bushing;
the worm shaft of the energy-saving actuating mechanism has a surface provided with a stepped stop flange abutting a side of the first threaded bushing so that the worm shaft is limited by the first threaded bushing;
the stop flange of the worm shaft is disposed between the driving head and the second worm thread;
the second worm thread of the worm shaft is disposed between the stop flange and the pivot rod;
the energy-saving actuating mechanism further includes:
a first gasket mounted on the worm shaft and biased between the worm shaft and the first pivot bore of the first threaded bushing; and
a second gasket mounted on the second threaded bushing and biased between the second threaded bushing and the second threaded hole of the base.

16. The grease gun of claim 1, wherein
the mounting seat of the boosting device has a periphery provided with a connecting hole connected to the flow channel or the inlet hole;
the grease gun further comprises a pressure gauge fitted into the connecting hole of the mounting seat and connected to the flow channel or the inlet hole to measure the pressure in the flow channel of the mounting seat.

17. The grease gun of claim 4, wherein
the external thread of the threaded rod is disposed between the driving portion and the stop edge;
the stop edge of the threaded rod is disposed between the external thread and the pivot portion;
the pivot portion of the threaded rod is disposed between the stop edge and the threaded locking portion; and
the threaded locking portion of the threaded rod is disposed between the pivot portion and the actuating portion.

18. The grease gun of claim 1, wherein
the mounting seat of the boosting device is located between the base and the cover;
the mounting chamber of the mounting seat is connected to the shaft hole of the base and is connected between the inlet hole and the flow channel;
the cover of the boosting device is located between the mounting seat and the connecting pipe;
the base is provided with a plurality of threaded fastening holes;
the mounting seat of the boosting device is provided with a plurality of fixing holes;
the cover of the boosting device is provided with a plurality of fixing bores;
the grease gun further comprises a plurality of fastening bolts extended through the fixing bores of the cover and the fixing holes of the mounting seat and screwed into the fastening holes of the base to combine the base, the mounting seat and the cover together.

19. The grease gun of claim 1, wherein
the shaft hole of the base is connected to the receiving space;
the passage of the base is connected to the receiving space;
the pivot hole of the end cap is connected to the receiving chamber of the barrel;
the threaded rod of the feeding unit is supported between the wormwheel and the end cap of the storage unit and is rotatable in the receiving chamber of the barrel.

20. The grease gun of claim 1, wherein
the receiving chamber of the barrel has a non-circular shape and is connected to the receiving space of the base;
the pressing plate of the feeding unit has a non-circular shape matching that of the receiving chamber of the barrel;
the pressing plate of the feeding unit is movable axially in the receiving chamber of the barrel by rotation of the threaded rod relative to the barrel of the storage unit.
